(19) United States
(12) Patent Application Publication
(10) Pub. No.: US 2011/0040443 A1
(43) Pub. Date: Feb. 17, 2011

(54) Method and Apparatus For Rapid Wheel Toe Angle Measurement and Adjustment

(75) Inventor: Blackford F. Brauer, St. Louis, MO (US)

Correspondence Address: Polster, Lieder, Woodruff & Lucchesi, L.C., 12412 Powerscourt Dr. Suite 200, St. Louis, MO, 63131-3615, US

(73) Assignee: HUNTER ENGINEERING COMPANY, Bridgeton, MO (US)

(21) Appl. No.: 12/857,675

(22) Filed: Aug. 17, 2010

Related U.S. Application Data
(60) Provisional application No. 61/234,379, filed on Aug. 17, 2009.

(51) Int. Cl. G01M 17/06; G01M 17/00; G06F 19/00; G01B 11/275

(52) U.S. Cl. 701/33; 33/228; 33/288

(57) ABSTRACT

A method for conducting a basic front-end wheel alignment measurement and adjustment procedure together with a routine vehicle maintenance procedure of a vehicle service shop. Vehicle front wheel turn plate assemblies, and optionally, vehicle rolling mechanisms, are incorporated into a support structure in a service area within the vehicle service shop at which the vehicle will undergo the maintenance procedures. When the vehicle is moved into the service area to undergo the maintenance procedures, basic measurements associated with the front-end wheel alignment are acquired by an associated service system, which prompts vehicle technicians to carry out a sequence of basic procedures to facilitate the acquisition of the basic measurements. Based on the results of the measurements, the service system provides the vehicle technicians with graphical guidance for performing any required adjustment to the vehicle front end wheel alignment, which may be carried out concurrent with other maintenance procedures.

### CROSS-REFERENCE TO RELATED APPLICATIONS

The present application is related to, and claims priority from, U.S. Provisional Patent Application Ser. No. 61/234,379 filed on Aug. 17, 2009, which is herein incorporated by reference.

### STATEMENT REGARDING FEDERALLY SPONSORED RESEARCH

Not Applicable.

### BACKGROUND OF THE INVENTION

The present application is related generally to methods and procedures for value-added maintenance of motor vehicles, and in particular, to a method and procedure for carrying out simplified vehicle front-end wheel alignment procedures in conjunction with other routine vehicle maintenance procedures.

Vehicle maintenance procedures, such as oil changes, muffler and exhaust system repairs, and brake services are often performed by automotive service shops specializing in basic automotive maintenance procedures. These service shops are generally not equipped to perform complicated vehicle repairs, but rather, selectively specialize in a particular area of vehicle maintenance, typically performing services which involve replacement or resupply of consumable components for the vehicle, and which do not require extensive technician training or specialized tools. In addition, these service shops typically operate with a rapid turn-around time for each vehicle undergoing the maintenance procedures, allowing customers to wait on-site while the maintenance procedures are completed.

One aspect of customer service provided by these types of vehicle service shops is a basic inspection of the vehicle undergoing a maintenance procedure, to identify to the customer additional value-added vehicle maintenance procedures which may optionally be performed at the same time, thereby providing additional service to the customer and an increased revenue to the vehicle service shop. For example, a vehicle brought in to a service shop for an oil change may additionally have all other fluid levels checked, the wear condition of the brake pads checked, the wiper blade condition inspected, tire inflation measured, and the air filter condition inspected. The customer is then presented with an itemized listing of any additional items which may be available for repair or replacement by the service shop while the vehicle is undergoing the maintenance procedures.

Vehicle service shops which specialize in basic vehicle maintenance procedures can benefit by offering additional services to their customers which may be carried out by the vehicle technicians without requiring extensive additional training, and which do not significantly increase the amount of time a vehicle technician is required to spend with each vehicle. Accordingly, it would be advantageous to provide methods and procedures for performing a basic inspection of, and adjustment to, a vehicle's front-end alignment during other routine vehicle maintenance procedures. It would be further advantageous to provide such methods and procedures which do not require extensive training of the vehicle technicians to carry out, which can be integrated with the routine vehicle maintenance procedures carried out by the vehicle service shop without significantly increasing the time required to complete the vehicle maintenance, and which thereby provide a value-added service which the vehicle service shop may offer to customers.

### BRIEF SUMMARY OF THE INVENTION

Briefly stated, the present disclosure provides a method for integrating a basic front-end wheel alignment measurement and adjustment procedure into the vehicle maintenance procedures of a limited-service vehicle service shop. Vehicle service bays in the vehicle service shop where a vehicle undergoes the maintenance procedures are modified to incorporate vehicle front wheel turnplate assemblies, and optionally, vehicle rolling mechanisms. When a vehicle is moved into the service area to undergo the maintenance procedures, basic measurements associated with the front-end wheel alignment are acquired by an associated service system. The associated service system prompts the vehicle technicians to carry out a sequence of basic procedures to facilitate the acquisition of the basic front-end wheel alignment measurements. Based on the results of these measurements, the service system then provides the vehicle technicians with graphical guidance for performing any required adjustment to the vehicle front end wheel alignment, which may be carried out concurrent with other maintenance procedures such as an oil change, brake repair or exhaust pipe replacement.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a floor plan view of an exemplary vehicle service shop, having three pit-style service bays, one of which is configured with an associated vehicle support structure;

FIG. 2 is a perspective view of a vehicle positioned for a service procedure in a vehicle service bay of FIG. 1;

FIG. 3 is a flow chart of an exemplary rapid toe angle adjustment procedure of the present disclosure incorporated into a vehicle service shop workflow;

FIG. 4 is a bar-graph type display of steered wheel measurement data; and

FIG. 5 is an illustration of a visual presentation of measured alignment angles for all four wheels of a vehicle.

Corresponding reference numerals indicate corresponding parts throughout the several figures of the drawings. It is to be understood that the drawings are for illustrating the concepts set forth in the present disclosure and are not to scale. Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

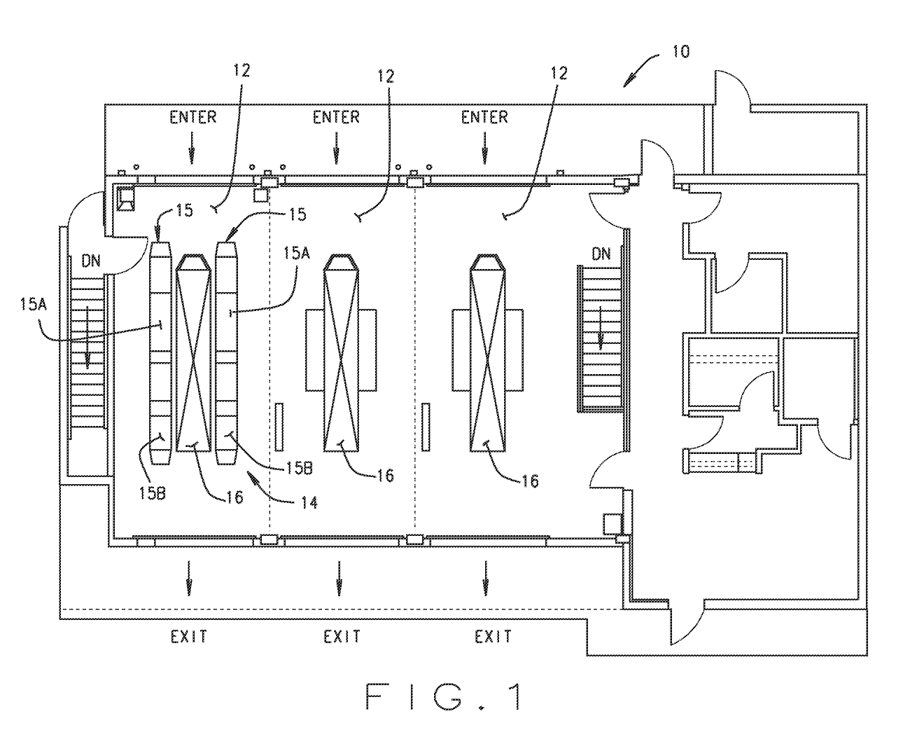

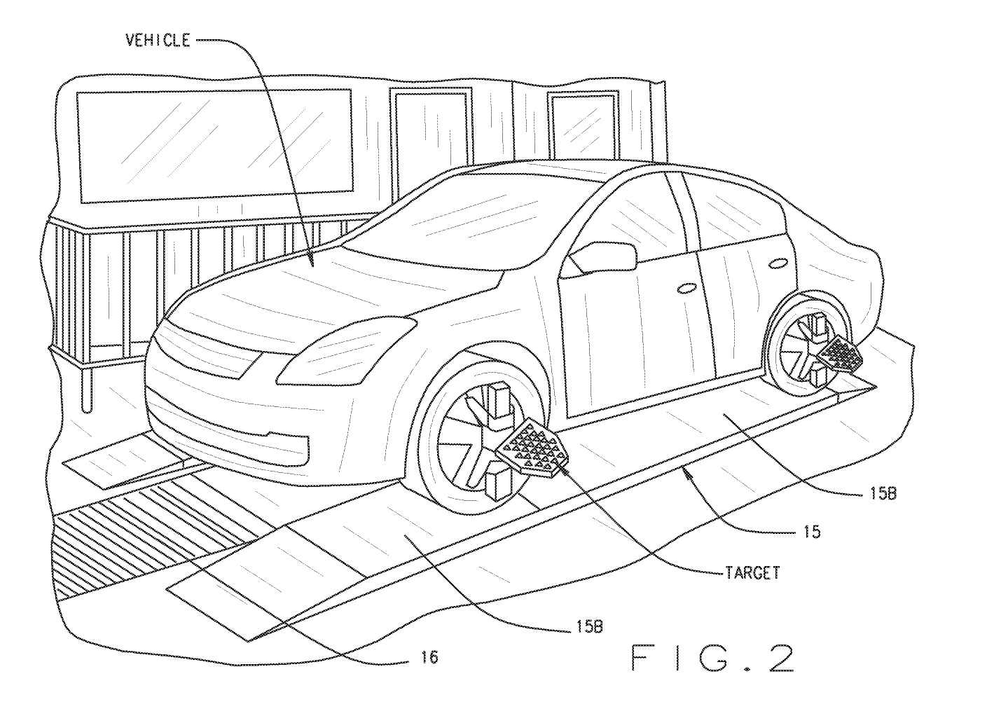

In general, a vehicle maintenance procedure carried out by a specialized automotive service shop 10, such as a quick-lube facility or a tire store shown in the exemplary floor plan of FIG. 1, begins with the vehicle undergoing the maintenance being brought into the maintenance area or service bay, or service location 12 in the service shop, such as shown in FIG. 2. Preferably, each maintenance area, service bay, or service location 12 in the service shop 10 is designed to accommodate a vehicle in a generally predetermined location, which may be on a vehicle support structure 14, such as a set of supporting runways 15 having integrated lift ramps 15A and turn plates 15B. or directly over an oil-change pit 16 in the floor of the service bay 12. The vehicle is brought into the service bay 12 and positioned at an initial position in the predetermined location, for example, on the supporting runways 15.

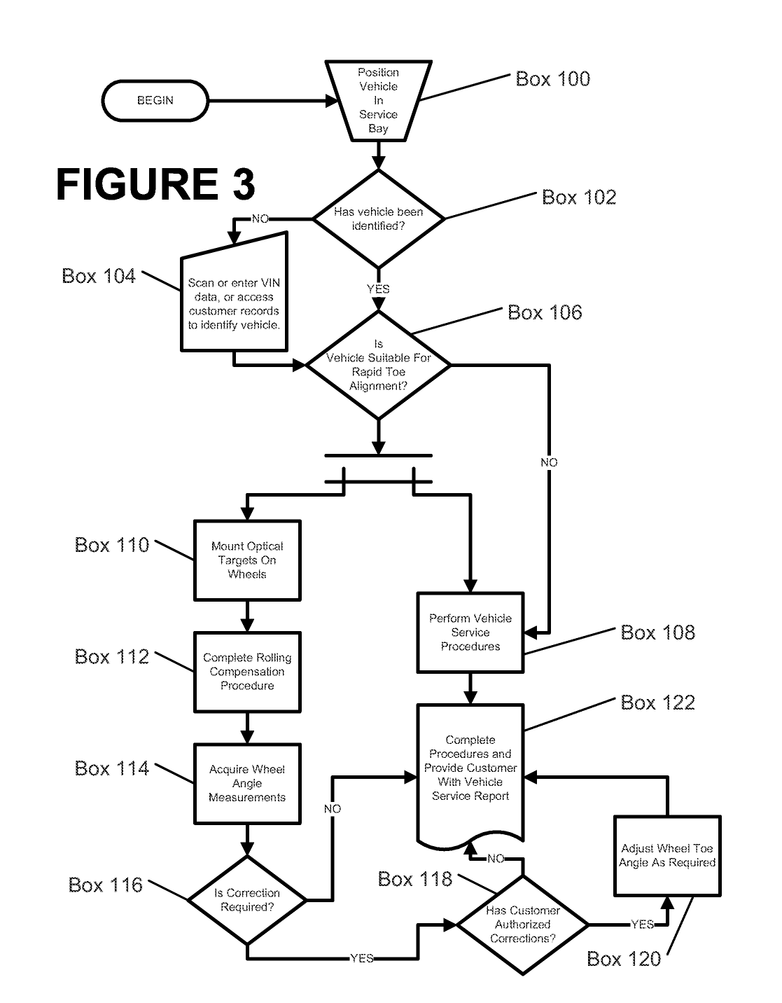

The methods of the present disclosure are generally carried out by a service technician under the guidance of a vehicle service system (not shown) associated with the service bay 12. The vehicle service system generally includes a console and computer-implemented suitable user interfaces for providing the technicians carrying out a vehicle maintenance procedure with access to customer records, shop supply inventory, and vehicle specification databases through a suitably programmed processing system. The processing system preferably is further configured with the necessary software instructions to implement the procedures of the present disclosure for a rapid front-end vehicle wheel alignment measurement and adjustment process, such as shown generally by the workflow of FIG. 3, and which are detailed herein.

Initially, the vehicle undergoing maintenance is positioned (Box 100) in the service bay 12 and must be identified (Box 102) to the vehicle service system. This may be done by any of a variety of well known methods, as indicated at Box 104, such as manual or automatic entry of a vehicle identification number (VIN), selection of a customer record, or selection of the vehicle via a menu-driven database of vehicle types accessed by a vehicle service system associated with the service bay 12.

Once the vehicle is properly identified to the processing system, a set of software instructions for carrying out the procedures of the present invention are processed to determine if the vehicle is suitable for a rapid front-end vehicle wheel alignment measurement and adjustment process (Box 106). Some vehicles may not be suitable for these procedures because they require specialized alignment measurement or adjustment procedures, special tools, or handling which are best carried out by specialized wheel alignment service technicians and full-service repair shops. Vehicle which are not suitable for the services offered by the present disclosure are identified, and the vehicle is processed according to whatever regular vehicle maintenance procedures were originally intended (i.e., oil change, tire change, brake pad replacement, etc.) as shown in Box 108.

If the vehicle is suitable for a front-end toe angle alignment measurement/adjustment procedure of the present disclosure, the software instructions configure the processing system to provide the operator with the necessary guidance to complete the process as part of the regular vehicle maintenance procedure which takes place in the service bay. The process may be carried out in parallel with the regular vehicle maintenance procedures, such as is illustrated by the flow charge of FIG. 3, or may be conducted in sequence with the regular vehicle maintenance procedures.

Wheel alignment angle measurements are obtained for the wheels of the vehicle using procedures which vary depending upon the particular type of sensors being utilized to acquire the measurements. Preferably, a machine-vision wheel alignment system is utilized, with optical targets (See: FIG. 2) having identifiable optical target elements mounted to the vehicle wheels, and imaged by suitable imaging sensors (not shown) coupled to the processing system.

The system instructs the operator to mount the sensors to the vehicle wheels in a conventional manner (Box 110), optionally to check and adjust the tire pressure levels to ensure that each tire is properly inflated, and to perform a rolling compensation procedure (Box 112) whereby the relationship between the mounted sensors and the axis of rotation for each wheel may be determined. As part of the rolling compensation procedure, the vehicle is rolled, either manually or automatically by hardware under control of the processing system, from an initial position in the service bay 12 to a service position. For example, the vehicle may be rolled forward a short distance to bring the front steerable wheels to rest on turn plates in the service bay, which are used to facilitate subsequent steps in the front end wheel alignment measurement procedure.

Once the front wheels are at rest on the turn plates 15B of the vehicle support structure 14, wheel angle measurements are obtained (Box 114). For example, the operator is instructed to level the steering wheel of the vehicle, and the processing system acquires data from which current measurements of the vehicle's toe angles for the front steerable wheels can determined. The determined toe angles are then displayed for the technician and are available for print-out to provide to the vehicle owner/operator. Additionally, once the vehicle is position on the turn-plates 15B, and is no longer being moved forward or backwards, the regular maintenance procedures for the vehicle (Box 108) may be carried out, such as an oil-change, fluid check, air filter replacement etc., while the technician consults with the vehicle owner/operator regarding the status of the vehicle's front end toe angle alignment measurements.

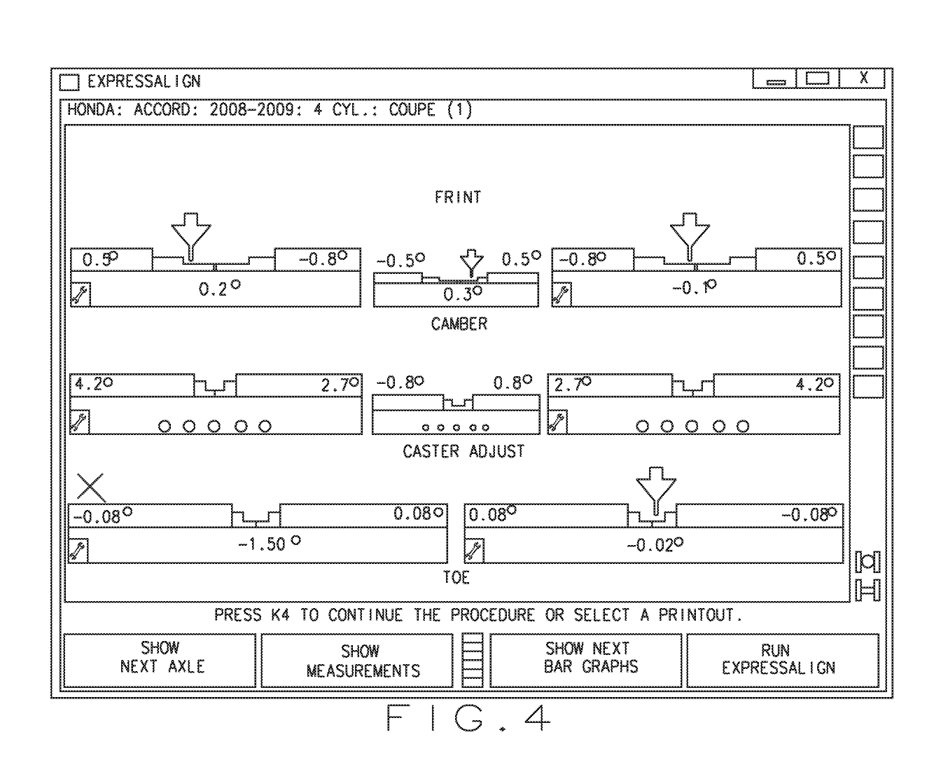

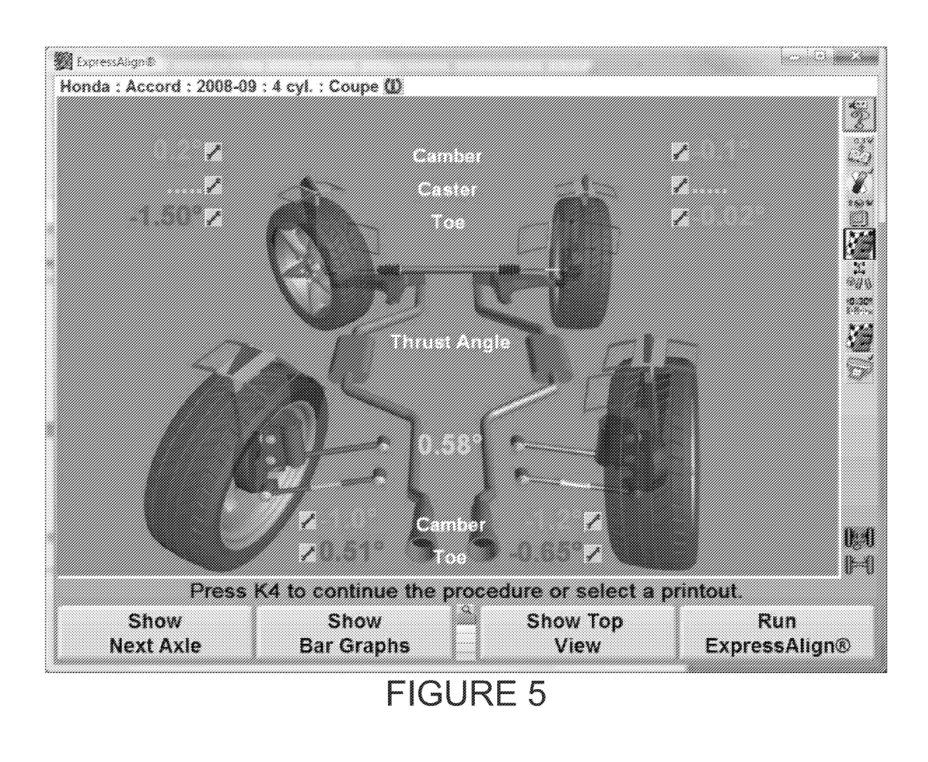

If a review (Box 116) of the measurements for the toe angles of the front steerable wheels of the vehicle reveals that the measurements are out-of-spec, i.e. require adjustment, the processing system may be prompted by the technician to confirm that repairs have been authorized by the customer (Box 118), and subsequently proceed with guiding the technician through a toe angle adjustment procedure (Box 120), such as by adjusting the tie rod linkage for each steerable wheel. Once the technician completes any required toe angle adjustments, the processing systems displays the adjusted toe angle, providing a confirmation of corrected toe angle alignment for the vehicle. Those of ordinary skill in the art will recognize that the measurements from the front-end toe angle alignment adjustment procedure may be displayed to the technician in a variety of forms, including bar-graph layouts as shown in FIG. 4 or three-dimensional representations as shown in FIG. 5. The results can be printed out, together with other measured front-end wheel alignment angles, in a format suitable for presentation to the vehicle owner/operator (Box 122) upon completion on the vehicle maintenance procedures.

The procedures of the present disclosure provide a simplified process for measuring and adjusting only a basic front-end vehicle wheel alignment angle, i.e. toe angles, and for automating portions of the measurement procedures to increase throughput and efficiency in a repair shop environment. By providing a simplified process (Boxes 110-120), the procedures may be carried out together with other routine vehicle maintenance procedures (Box 108), such as oil changes, fluid level checks, etc., to provide quick-service vehicle shops 10 with an additional beneficial service/repair which can be offered to vehicle owners/operators when they bring a vehicle into the shop for a routine maintenance procedure. In addition to providing the vehicle repair shop 10 with a value-added service option for customers, the methods of the present disclosure allow a technician to identify potential damage or misalignment to a vehicle which may require specialized corrective repair, and provide the necessary notification to the vehicle owner/operator (Box 122).

It will additionally be understood that while the procedures of the present disclosure are intended only to provide adjustment to the toe angles for the front steerable wheels of a vehicle, in order to facilitate a rapid adjustment and correction thereof during, or in conjunction with, other routine vehicle maintenance procedures (Box 108), and that additional wheel alignment angle measurements may be acquired by the processing system as part of the measurement process. These additional measurements, such as camber and caster angles for either the front wheels or the rear wheels of the vehicle, may additionally be displayed and/or printed out for either the technician or vehicle owner/operator to review as part of the vehicle service report provided to the customer (Box 122). These may be used to recommend additional repairs and/or vehicle services to the vehicle owner/operator.

The present disclosure can be embodied in-part in the form of computer-implemented processes and apparatuses for practicing those processes. The present disclosure can also be embodied in-part in the form of computer program code containing instructions embodied in tangible media, such as floppy diskettes, CD-ROMs, hard drives, or an other computer readable storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. A method for performing a maintenance procedure on a vehicle, comprising:
receiving the vehicle in a vehicle maintenance area to initiate at least one selected vehicle maintenance procedure together with a front-end vehicle wheel alignment procedure;
subsequent to receipt of the vehicle in said vehicle maintenance area, acquiring a set of vehicle wheel alignment angle measurements associated with at least the front steerable wheels of the vehicle;
responsive to said acquired set of vehicle wheel alignment angle measurements, conducting a corrective adjustment to an alignment angle associated with the front steerable wheels of the vehicle;
completing the selected vehicle maintenance procedure prior to departure of the vehicle from said vehicle maintenance area; and
wherein said selected vehicle maintenance procedure is selected from a set of vehicle maintenance procedures including a fluid replacement service, a brake pad replacement service, and exhaust system service.

2. The method of claim 1 wherein said alignment angle associated with the front steerable wheels of the vehicle is a toe angle.

3. The method of claim 1 wherein said step of acquiring a set of vehicle wheel alignment angle measurements is at least partially automated.

4. The method of claim 1 wherein said vehicle maintenance area is an oil-change service bay.

5. The method of claim 1 wherein said step of acquiring said set of vehicle wheel alignment measurements includes rolling the vehicle to measure runout of at least the front steerable wheels.

6. The method of claim 5 wherein rolling of the vehicle is automated.

7. A method for measuring and adjusting front-end wheel alignment of a vehicle in an oil-changing service bay, comprising:
positioning the vehicle on a support structure in said oil-changing service bay;
acquiring measurements of at least one front-end wheel alignment angle of the vehicle;
responsive to an out-of-spec acquired measurement, adjusting the front-end wheel alignment of the vehicle;
completing an oil change maintenance procedure on the vehicle; and
removing the vehicle from said oil-changing service bay.

8. The method of claim 7 wherein said front-end wheel alignment angle includes at least a toe angle for a steerable wheel of the vehicle.

9. A method for identifying at least one recommended vehicle wheel alignment service to a vehicle operator during a routine vehicle maintenance procedure, comprising:
positioning a vehicle in a vehicle service bay for said routine vehicle maintenance procedure, said routine vehicle maintenance procedure selected from a set of vehicle maintenance procedures including a fluid replacement service, a brake pad replacement service, and exhaust system service;
acquiring, during said positioning, wheel alignment angle measurements associated with at least the front steerable wheels of the vehicle;
presenting a display of said wheel alignment angle measurements to the vehicle operator; and
completing said routine vehicle maintenance procedure prior to removing the vehicle from said vehicle service bay.

10. The method of claim 9 further including the steps of evaluating the acquired wheel alignment angle measurements to identify at least one recommended alignment adjustment for the vehicle; and
presenting said at least one identified recommended alignment adjustment to the vehicle operator.

11. The method of claim 9 wherein said recommended alignment adjustments include at least a toe angle alignment adjustment for a front steerable wheel of the vehicle.

12. A method for identifying recommended vehicle wheel alignment services to a vehicle operator during a routine vehicle maintenance procedure, comprising:
positioning a vehicle in a vehicle service bay for said routine vehicle maintenance procedure, said routine vehicle maintenance procedure selected from a set of routine vehicle maintenance procedures including a fluid replacement service, a brake pad replacement service, and exhaust system service;
evaluating suitability of the vehicle for front-end toe angle alignment adjustment; and
completing said vehicle maintenance procedure prior to removing the vehicle from said vehicle service bay.

13. The method of claim 12 further including, in response to said evaluation indicating suitability of the vehicle for said front-end toe angle alignment adjustment, acquiring, during said positioning, wheel alignment angle measurements associated with at least the toe angles of the front steerable wheels of the vehicle;
evaluating the acquired wheel alignment angle measurements to identify required toe angle alignment adjustments; and
completing each required toe angle alignment adjustment.
